(19) United States
(12) Patent Application Publication
(10) Pub. No.: US 2025/0081106 A1
(43) Pub. Date: Mar. 6, 2025

(54) COMMUNICATION METHOD UNDER MULTIPLE LINKS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/559,959

(22) PCT Filed: May 11, 2021
(86) PCT No.: PCT/CN2021/093132

§ 371 Date: Nov. 9, 2023

(51) Int. Cl. H04W 52/02

(52) U.S. Cl. CPC H04W 52/0235

(57) ABSTRACT

Provided in the present disclosure are a communication method under multiple links. The communication method may include: determining a first message frame, wherein the first message frame comprises information that at least one link of multiple links is to be switched to an awake state for multi-link communication; and sending the first message frame.

### CROSS-REFERENCE TO RELATED APPLICATIONS

The present application is a U.S. National Stage of International Application No. PCT/CN2021/093132, filed on May 11, 2021, the entire contents of which are incorporated herein by reference for all purposes.

### TECHNICAL FIELD

The present disclosure relates to the field of wireless communication, and in particular, to a communication method under multiple links, an electronic device, and a storage medium.

### BACKGROUND

The current Wi-Fi technology is studied in the scope of 320 MHz bandwidth transmission, aggregation and collaboration of multiple bands, etc., and is expected to be able to improve at least four times the rate and throughput relative to the existing standard, and its main application scenarios include video transmission, Augmented Reality (AR), Virtual Reality (VR), etc.

The aggregation and collaboration of multiple bands means that devices communicate simultaneously in 2.4 GHz, 5 GHZ, and 6 GHz bands, etc. A new Media Access Control (MAC) mechanism needs to be defined to manage the simultaneous communication between devices in multiple bands. In addition, it is expected that the aggregation and collaboration of multiple bands can support low-latency transmission.

The maximum bandwidth that will be supported in the current multi-band aggregation and collaboration technology is 320 MHz (160 MHz+160 MHz). In addition, 240 MHz (160 MHz+80 MHz) and other bandwidths may also be supported.

In the current technology, a Station (STA) and an Access Point (AP) may be a multi-link device (MLD), i.e., support the ability to simultaneously transmit and/or receive under multiple links at the same moment. Therefore, in the current technology, multiple links may exist between the STA and the AP, and the communication between these two devices under multiple links is being investigated.

### SUMMARY

Various embodiments of the present disclosure provide the following technical solutions.

According to the first embodiments of the present disclosure, a communication method under multiple links is provided. The communication method may include: determining a first message frame, wherein the first message frame includes information that at least one link of multiple links is to be switched to an awake state for multi-link communication; and sending the first message frame.

According to the second embodiments of the present disclosure, a communication method under multiple links is provided. The communication method may include: receiving a first message frame, wherein the first message frame includes information that at least one link of multiple links is to be switched to an awake state for multi-link communication; and performing a communication operation based on the first message frame.

According to the third embodiments of the present disclosure, an electronic device is provided. The electronic device includes a memory, a processor and a computer program stored in the memory and runnable on the processor. The processor executes the computer program to implement the methods as described above.

According to the fourth embodiments of the present disclosure, a non-transitory computer-readable storage medium is provided. The computer-readable storage medium has stored thereon a computer program which, when executed by a processor, causes the processor to implement the methods as described above.

### BRIEF DESCRIPTION OF THE DRAWINGS

The above, as well as other, features of the embodiments of the present disclosure will become more apparent by describing the embodiments of the present disclosure in detail with reference to the accompanying drawings.

FIG. 1 is a schematic diagram illustrating a communication scenario under multiple links.

FIG. 2 is a flowchart illustrating a communication method under multiple links according to an embodiment.

FIG. 3 illustrates an interactive communication between an initiator and a receiver according to an embodiment.

FIG. 4 illustrates an interactive communication between an initiator and a receiver according to an embodiment.

FIG. 5 is a flowchart illustrating another communication method under multiple links according to an embodiment.

FIG. 6 is a block diagram illustrating a communication apparatus under multiple links according to an embodiment.

### DETAILED DESCRIPTION

The following description with reference to the accompanying drawings is provided to assist in fully understanding the various embodiments of the present disclosure as defined by the appended claims and their equivalents. The various embodiments of the present disclosure include various specific details. However, these specific details are considered exemplary only. In addition, descriptions of well-known techniques, functions, and constructions may be omitted for clarity and brevity.

Terms and phrases used in the present disclosure are not limited to their written meaning, but are used only by the inventor to enable a clear and consistent understanding of the present disclosure. Accordingly, the description of various embodiments of the present disclosure is provided for illustrative purposes only and not for limiting purposes to those skilled in the art.

It should be understood that the singular forms “one”, “a/an”, “the/said” and “this” used herein may also include the plural form, unless the context clearly indicates otherwise. It should be further understood that the term “including” as used in the present disclosure refers to the presence of the described features, integers, steps, operations, elements and/or components, but does not preclude the presence of, or the addition of, one or more other features, integers, steps, operations, elements, components, and/or a combination thereof.

It will be understood that while the terms “first”, “second”, etc. may be used herein to describe various elements, these elements should not be limited by these terms. These terms are only used to distinguish one element from another. Thus, without departing from the teachings of the embodiments, the first element discussed below may be referred to as a second element.

It should be understood that when an element is referred to as being “connected” or “coupled” to another element, it may be directly connected or coupled to the other element, or there may be an intervening element. In addition, “connected” or “coupled” as used herein may include wirelessly connected or wirelessly coupled. The term “and/or” or the expression “at least one of . . . ” as used herein includes any and all combinations of one or more of the listed items as relevant.

Unless otherwise defined, all terms used herein, including technical and scientific terms, have the same meaning as generally understood by those of ordinary skill in the art to which this disclosure belongs.

FIG. 1 is a schematic diagram illustrating a communication scenario under multiple links.

In a wireless local area network (LAN), a Basic Service Set (BSS) may consist of an AP and one or more stations (STAs) that communicate with the AP. A BSS may be connected to a Distribution System (DS) through its AP and then to another BSS to form an Extended Service Set (ESS).

The AP is a wireless switch used in wireless networks and is also the core of wireless networks. An AP device may be used as a wireless base station, mainly a bridge used to connect a wireless network to a wired network. The wired and wireless networks can be integrated using the AP.

The AP may include software applications and/or circuitry to enable other types of nodes in the wireless network to communicate with the outside as well as the inside of the wireless network via the AP. In some examples, the AP may be a terminal device or network device equipped with a Wireless Fidelity (Wi-Fi) chip.

For example, the station (STA) may include, but is not limited to: a cellular phone, a smart phone, a wearable device, a computer, a personal digital assistant (PDA), a personal communication system (PCS) device, a personal information manager (PIM), a personal navigation device (PND), a global positioning system (GPS), a multimedia device, an Internet of Things (IoT) device, and the like.

In some embodiments of the present disclosure, the AP and the STA may be the devices that support multiple links, for example, may be denoted as AP MLD and non-AP STA MLD, respectively, as shown in FIG. 1. For ease of description, the following mainly describes an example in which one AP communicates with one STA under multiple links. However, the embodiments of the present disclosure are not limited thereto.

In FIG. 1, for exemplary purposes only, an AP MLD may represent an access point that supports a multi-link communication function, and a non-AP STA MLD may represent a station that supports a multi-link communication function. Referring to FIG. 1, the AP MLD may operate under three links, such as AP1, AP2, and AP3 as shown in FIG. 1, and the non-AP STA MLD may also operate under three links, such as STA1, STA2, and STA3 as shown in FIG. 1. In the example of FIG. 1, it is assumed that AP1 communicates with STA1 via a corresponding first link (Link 1), and similarly, AP2 and AP3 communicate with STA2 and STA3 via a second link (Link 2) and a third link (Link 3), respectively. Furthermore, Link I to Link 3 may be a plurality of links at different frequencies. e.g., links at 2.4 GHZ, 5 GHz, 6 GHZ, etc., or several links with the same or different bandwidths at 2.4 GHz, 5 GHZ, or 6 GHz. In addition, a plurality of channels may exist under each link. However, it should be understood that the communication scenario shown in FIG. 1 is only exemplary and the inventive concept is not limited thereto, e.g., the AP MLD may be connected to a plurality of non-AP STA MLDs, or under each link, the AP may communicate with a plurality of other types of stations.

In power save (PS) mode, the device (e.g., non-AP STA MLD and its attached stations STA1, STA2, and STA3) saves power by setting a power management (PM) subfield of the header of the control frame to “1”, and entering into the power save mode after receiving a response from the opposite side (e.g., AP MLD and its attached access points AP1. AP2, and AP3). In a multi-link communication environment, stations that are under different links may enter into the power save mode. In this case, when a link becomes enabled for a STA that is part of a non-AP MLD through multi-link setup sent on that link, the initial power management mode of the STA, immediately after the signaling exchange, is active mode; and when a link is enabled for a STA that is part of a non-AP MLD through signaling (multi-link setup or TID to link mapping update) send on another link, the initial power management mode of the STA, immediately after the exchange, is power save mode, and its power state is doze. Each STA of a non-AP MLD that is operating on an enabled link shall maintain its own power management mode and power state as defined Power management and Target wake time (TWT). Frame exchanges on an enabled link are possible when the STA of the non-AP MLD operating on that link is in the awake state.

In a multi-link situation, the device is required to support multi-link communication, e.g., multi-link communication in a simultaneous transmit and receive (STR) manner or non-simultaneous transmit and receive (NSTR) manner. According to the above description of the power save mode for each link, if a link (e.g., Link 1 in FIG. 1) is activated by signaling sent in another link (e.g., Link 3 in FIG. 1) during an initial association process (e.g., multi-link setup) or during a communication identity-to-link mapping process (i.e., TID-to-Link mapping process), the station under this link (e.g., Link 1) may be in power save mode after the signaling interaction is completed. Subsequently, if STR or NSTR communication is to take place between the devices, the station in PS mode requires to be awakened. However, the prior art lacks an awake mechanism for this situation.

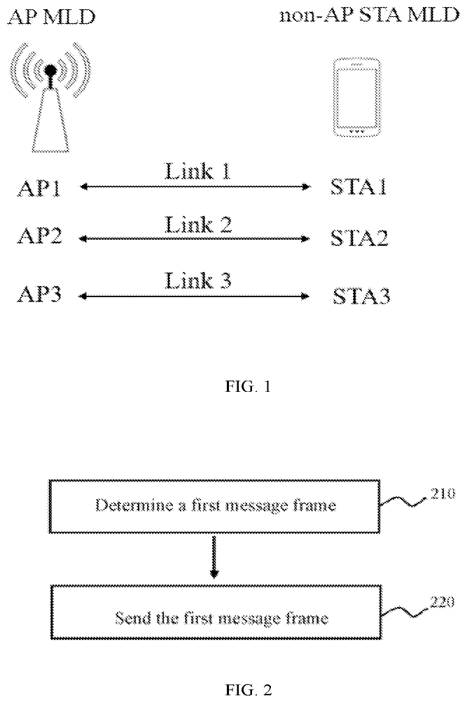

FIG. 2 is a flowchart illustrating a communication method under multiple links according to an embodiment. The communication method shown in FIG. 2 may be applied to an initiator, e.g., a non-AP STA MLD or an AP MLD. In the case where the initiator is a non-AP STA MLD, the corresponding receiver may be an AP MLD. In the case where the initiator is an AP MLD, the corresponding receiver may be a non-AP STA MLD.

Referring to FIG. 2, in step 210, a first message frame may be determined. According to some embodiments, the first message frame may include: information that at least one link of multiple links is to be switched to an awake state for multi-link communication. According to some embodiments of the present disclosure, the multiple links may be established between an initiator and a receiver, and the at least one link may be a link that is about to be awakened for multi-link communication. The first message frame may be referred to as an initial message frame for the multi-link communication. In the embodiments of the present disclosure, such initial message frame (the first message frame) is defined in order to awake a station in PS mode for multi-link communication.

According to some embodiments, the information included in the first message frame may be carried in the form of an information element (IE) and may include at least one of: a power management identifier, a link identifier, or a delay identifier.

By way of example only, the information included in the first message frame may have a format as shown in Table 1 below.

TABLE 1
Format of the information included in the first message frame

| | | | | | | |
|---|---|---|---|---|---|---|
| . . . | PM | Link ID1 | Delay 1 | Link ID2 | Delay 2 | . . . |

It is to be understood that each of the elements shown in Table 1 are independent, and that these elements are exemplarily listed in the same table, but it does not mean that all of the elements in the table have to be present at the same time according to what is shown in the table. Thus it will be understood by those skilled in the art that each of the elements in Table 1 of the present disclosure is a separate embodiment. It will also be understood that the elements shown in Table 1 are merely exemplary and that the present disclosure is not limited thereto. For example, Table 1 may also include elements such as Element ID, Length, or may omit a portion of the elements from Table 1.

Referring to Table 1, the information included in the first message frame may include a power management identifier PM. According to some embodiments, when this power management identifier is set to a first value (such as but not limited to “0”), it indicates that the at least one link is to be switched to the awake state. Although only one PM is shown in Table 1, according to some embodiments of the present disclosure, more PMs may be included, e.g., there may be PMs corresponding to Link ID1 and Link ID2, etc., respectively.

According to some embodiments of the present disclosure, the information included in the first message frame may include a link identifier corresponding to at least one link that is to be switched to the awake state, such as Link ID1 and Link ID2 in Table 1, etc. In one embodiment, the link identifier may be represented by each Link ID, as shown in Table 1, in which case each Link ID may have a plurality of bits to identify a combination of the following information: operating spectrum, bandwidth/channel, and base service set identifier (BSSID). Representing the link identifier with a separate Link ID enables a simple coding and decoding method to be used for carrying the information. In another embodiment, unlike that shown in Table 1, the link identifier may be represented by a link set, in which case the link set may have a plurality of bits, each bit corresponding to a link of a plurality of links established between the initiator and the receiver, and when a bit is set to a particular value (such as but not limited to “1”), the link corresponding to the bit may be switched to the awake state. Representing the link identifier in terms of a link set may reduce the number of bits of information, thereby reducing the amount of data to be transmitted in the communication.

When “PM” in Table 1 is set to the first value, it may be indicated that the links identified by the link identifiers Link ID1 and Link ID2, etc., is about to be switched to the awake state. That is, the device (e.g., station STA) corresponding to the link identifiers Link ID1 and Link ID2, etc., is about to be awakened to conduct multi-link communication. Although both the PM and the link identifiers Link ID1 and Link ID2, etc. are shown in Table 1, the present disclosure is not limited thereto. For example, when all of the plurality of links established between an initiator and a receiver is to be awakened, one of the PM and the link identifier may be omitted, thereby streamlining signaling.

According to some embodiments of the present disclosure, the information included in the first message frame may further include a delay identifier, such as Delay 1 and Delay 2 in Table 1. The delay identifier may be used to identify a delay for a device under at least one link to switch to the awake state. For example, in Table 1, Delay 1 may refer to a delay for a device (e.g., station STA) corresponding to Link ID I to switch from a doze state to an awake state, or may refer to a maximum delay for switching from the doze state to the awake state. Although multiple delay identifiers such as Delay 1 and Delay 2 are shown in Table 1, only one delay identifier may be included if the device under the links that are to be switched to the awake state has the same delay. Alternatively, the delay identifier may even be omitted when immediate switching to the awake state is required.

In addition, Delay 1, Delay 2, etc. may also be identified in a multi-link (ML) information element, i.e., located in a different information element than the PM and Link ID1, Link ID2. Delay 1, Delay 2, etc. may be, for example, 0 μs, 8 μs, etc. In general, the value of the delay may be the same under each link.

With continued reference to FIG. 2, in step 220, the first message frame may be sent. For example, the first message frame may be sent from the initiator to the receiver under any link of multiple links, wherein said any link is not a link that is in a power save mode. According to some embodiments of the present disclosure, step 220 may be performed after the multi-link establishment is completed. In other words, step 220 is performed before the multi-link communication.

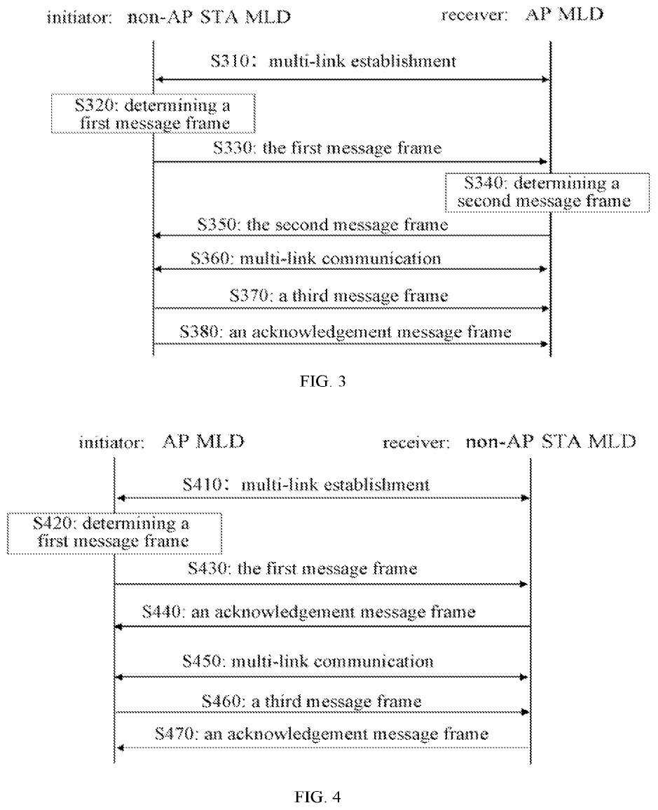

It is to be understood that the embodiment shown in FIG. 2 is merely exemplary and the present disclosure is not limited thereto. Although not shown, the communication method in FIG. 2 may also include, for example, receiving a second message frame from an access point (i.e., AP MLD) that supports multi-link communication when the first message frame is sent by a station (i.e., non-AP STA MLD) that supports multi-link communication. The second message frame may include information that a link that is to be switched to an awake state recommended by the access point based on a communication environment. According to some embodiments, the communication environment may include a load condition and/or an access delay, however, the present disclosure is not limited thereto. For example, the communication environment may also include: a network condition, a hardware capability of the transmitting/receiving device, a type of service, or may be regulated by a relevant protocol, and the like. This will be described in more detail below with reference to FIG. 3.

FIG. 3 illustrates interactive communications between an initiator and a receiver according to an embodiment. In FIG. 3, the initiator may be a non-AP STA MLD and the receiver may be an AP MLD.

Referring to FIG. 3, in S310, a multi-link establishment may be performed between the initiator non-AP STA MLD and the receiver AP MLD. For example, multiple links may be established by that: the initiator non-AP STA MLD may send a probe request frame, an association request frame, or a reassociation request frame, etc., to the receiver AP MLD, and receive a feedback frame, e.g., a probe response frame, an association response frame, or a reassociation response frame, etc., from the receiver AP MLD. It is to be understood that this is illustrative only, and embodiments of the multi-link establishment are not limited thereto. In addition, S310 may also indicate a TID-to-Link mapping process.

Then, when a multi-link communication is required, the initiator non-AP STA MLD may determine the first message frame in S320 and send the first message frame in S330. As shown in the embodiments of FIG. 2 and Table 1, the first message frame may carry at least one of the power management identifier, the link identifier, or the delay identifier, i.e., S320 and S330 may be analogous to steps 210 and 220 described with reference to FIG. 2, and repetitive descriptions are omitted herein for brevity. In the case where the initiator is a non-AP STA MLD, in order to conduct a multi-link communication, the non-AP STA MLD may determine, based on its own communication conditions, the link that is to be switched to the awake state, and send the relevant information to the AP MLD.

In S340, the AP MLD, upon receiving the first message frame, may be informed, by parsing, of the information of the link determined by the non-AP STA MLD to be awakened, and may determine, accordingly, whether or not the link is acceptable. If the AP MLD determines, e.g., according to its communication environment, that the link determined by the non-AP STA MLD are unacceptable, it may recommend to the non-AP STA MLD a link that is to be awakened for multi-link communication, for example, by sending a second message frame in S350. In this case, the second message frame may include information that a link is to be switched to the awake state recommended by the access point based on a communication environment. According to some embodiments, the communication environment may include a load situation and/or an access delay, but the present disclosure is not limited thereto. For example, the communication environment may also include: a network condition, a hardware capability of the transmitting/receiving device, a type of service, or may be regulated by a relevant protocol, and the like. If the AP MLD determines, e.g., according to its communication environment, that the link determined by the non-AP STA MLD is acceptable, S340 and S350 may be omitted, and an acknowledgement message frame may be fed back to the non-AP STA MLD, after which the multi-link communication is performed in S360. In some embodiments of the present disclosure, the initiator and the receiver may negotiate the link that is to be awakened for multi-link communication via S320 to S350, increasing the flexibility of the system.

In S360, after the initiator and the receiver have negotiated a link for the multi-link communication, the multi-link communication may be performed at the initiator and the receiver, e.g., to perform signaling interactions or data transmissions under the multiple links in a STR or NSTR manner.

In S370, when the multi-link communication is complete, the initiator may send a third message frame to the receiver. The third message frame may include information that a link in the awake state in the at least one link is to enter into a power save mode. For example, the third message frame may carry a link identifier and/or a PM that is set to a second value (such as but not limited to “1”) to identify that the corresponding link will enter into the power save mode. Optionally, the third message frame may carry a delay identifier that identifies that the corresponding link will enter into the power save mode after a certain delay, thereby improving the reliability of the multi-link communication.

In S380, the initiator may receive an acknowledgement message frame from the receiver regarding the third message frame. That is, after the multi-link communication is complete, the initiator may inform, through S370 and S380, the receiver that the link identified in S320 or S340 may go from the awake state to the doze state, thereby enabling the device (station) to enter into the power save mode to save power.

FIG. 4 illustrates interactive communications between an initiator and a receiver according to an embodiment. In FIG. 4, the initiator may be an AP MLD and the receiver may be a non-AP STA MLD.

Referring to FIG. 4, in S410, a multi-link establishment may be performed between the initiator AP MLD and the receiver non-AP STA MLD. For example, the multiple links may be established by that: the initiator AP MLD may broadcast a beacon frame to the receiver non-AP STA MLD; the receiver non-AP STA MLD, after receiving the beacon frame, may send an association request frame or a reassociation request frame to the initiator AP MLD; and the initiator AP MLD may feedback an association response frame or a reassociation response frame to accomplish the multi-link establishment. It is to be understood that this is illustrative only, and embodiments of the multi-link establishment are not limited thereto. In addition, S410 may also indicate a TID-to-Link mapping process.

Then, when a multi-link communication is required, the initiator AP MLD may determine a first message frame in S420 and send the first message frame in S430. As shown in the embodiments in FIG. 2 and Table 1, the first message frame may carry at least one of: the power management identifier, the link identifier, or the delay identifier. In S420, when the initiator AP MLD determines the first message frame, the initiator AP MLD may determine a link that is to be awakened for multi-link communication based on a communication environment (e.g., a load condition, an access latency, a network condition, a hardware capability of the transmitting/receiving device, a type of service, or may be regulated by a relevant protocol, etc.). The first message frame in S420 may have a format similar to that described with reference to Table 1, and repeated descriptions are omitted herein to avoid redundancy.

In S440, the initiator AP MLD may receive an acknowledgement message frame from the receiver non-AP STA MLD, i.e., the initiator confirms that the non-AP STA MLD is aware of the link that is to be awakened. The multi-link communication may then be performed in S450.

In S460, when the multi-link communication is complete, the initiator AP MLD may send a third message frame to the receiver non-AP STA MLD. In S470, the initiator AP MLD may receive an acknowledgement message frame regarding the third message frame from the receiver non-AP STA MLD, such that at least one link in the multi-link communication that is in the awake state may be entered into the power save mode.

Although not shown in FIG. 4, the receiver non-AP STA MLD, after being informed via S430 of the link determined by the initiator AP MLD to be switched to the awake state, may also recommend to the initiator AP MLD other links to be used for the multi-link communication based on its own communication conditions.

The method of communication under multiple links according to embodiments of the present disclosure may define an initial message frame (e.g., the first message frame) for multi-link communication, the initiator of which may be a non-AP STA MLD or an AP MLD (regardless of the fact that it will be in PS mode).

Specifically, the initial message frame (e.g., the first message frame) is sent under any link (including a multi-link setup/TID-to-Link mapping link) that is to be used in the multi-link communication. The subfield, Power Management, of a frame control field of the initial message frame (e.g., the first message frame) is set to, for example “0”, identifying that the link is to be switched to the awake state. In addition, an identification of the link that is about to enter into the awake state may also be included in the initial message frame (e.g., the first message frame). Specifically, the initial message frame may be in the form of an IE, e.g., link ID+PM identification bit, and there may be a plurality of link IDs (e.g., links that have been activated during the initial association process). Optionally, the initial message frame (e.g., the first message frame) may include a delay for the device under each link to switch from the doze state to the awake state, or a maximum delay required for the device to switch to the awake state.

Then, the receiver of the initial message frame (e.g., the first message frame) may feed back to the initiator an acknowledgement message frame regarding the initial message frame. For example, the receiver may feedback a simple acknowledgement frame to the initiator. For another example, if the receiver is an AP MLD, the receiver AP MLD may recommend a link to be awakened to the non-AP STA MLD based on the BSS load situation under the link to be awakened, the access delay, and other factors, e.g., in the acknowledgment message frame (e.g., the second message frame) that is fed back.

Upon completion of the multi-link communication, the initiator may set the subfield, Power Management, of the frame control field of the last frame to, for example, “1”, identifying the entry into the PS mode, and the receiver may feedback an acknowledgement message frame in response to the last frame.

The communication method according to embodiments of the present disclosure may reduce the signaling interactions in multi-link communication, enable the station in a PS state to engage in multi-link communication, and improve the efficiency of spectrum utilization.

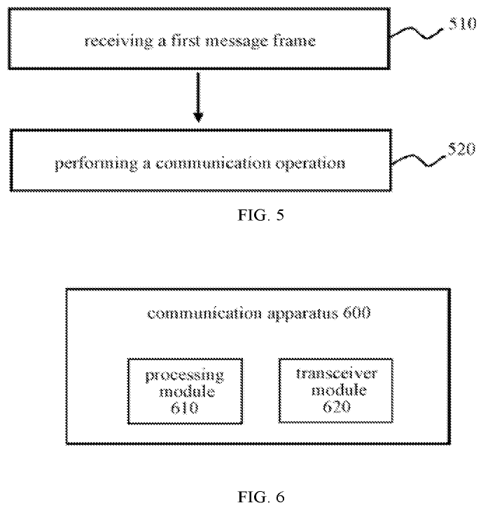

FIG. 5 is a flowchart illustrating another communication method under multiple links according to an embodiment. The communication method shown in FIG. 5 may be applied to a receiver, e.g., the receiver may be an AP MLD or a non-AP STA MLD. In the case where the initiator executing the communication method shown in FIG. 2 is a non-AP STA MLD, the receiver executing the communication method of FIG. 5 may be an AP MLD; in the case where the initiator is an AP MLD, the corresponding receiver may be a non AP STA MLD.

Referring to FIG. 5, in step 510, a first message frame may be received. According to some embodiments, the first message frame includes: information that at least one link of multiple links is to be switched to an awake state for multi-link communication. Specifically, according to embodiments, the information may include: a power management identifier, wherein when this power management identifier is set to a first value, it indicates that the at least one link is to be switched to the awake state. According to some embodiments, the information may include: a link identifier corresponding to the at least one link. According to some embodiments, the information may further include: a delay identifier, wherein the delay identifier may be used to identify a delay for the device under the at least one link to switch to the awake state. That is, as in the embodiment in Table 1, the first message frame may carry at least one of a power management identifier, a link identifier, or a delay identifier, the repetitive description of which is omitted herein for the sake of brevity.

In step 520, a communication operation may be performed based on the first message frame. For example, the receiver may feed an acknowledgement message frame to the initiator as shown in S440 of FIG. 4. For another example, in the case where the first message frame is received by an access point that supports multi-link communication (the receiver is an AP MLD) as shown in S340 and S350 of FIG. 3, the receiver may send a second message frame to a station that supports multi-link communication (the initiator is a non-AP STA MLD), wherein the second message frame may include information that a link is to be switched to an awake state recommended by the access point based on a communication environment (e.g., a load condition and/or an access latency, etc.). The information carried in the second message frame may include at least one of: a power management identifier, a link identifier, or a delay identifier, i.e., may be in a format similar to that of Table 1, with repetitive descriptions omitted herein for brevity.

Although not shown in FIG. 5, the communication method shown in FIG. 5 may further include: receiving a third message frame, wherein the third message frame may include information that a link in the awake state in the at least one link is to enter into a power save mode, i.e., S370 and S460 in FIGS. 3 and 4.

It is to be understood that the communication method shown in FIG. 5 is only exemplary and the present disclosure is not limited thereto, for example, the communication method shown in FIG. 5 may include the operations in FIGS. 3 and 4 that are performed by the receiver.

FIG. 6 is a block diagram illustrating a communication apparatus 600 under multiple links according to an embodiment. Referring to FIG. 6, the communication apparatus 600 may include a processing module 610 and a transceiver module 620.

The communication apparatus shown in FIG. 6 may be applied to either the initiator or the receiver. For example, in the case where the initiator is a non-AP STA MLD, the corresponding receiver may be an AP MLD: in the case where the initiator is an AP MLD, the corresponding receiver may be a non-AP STA MLD.

In the case where the communication apparatus shown in FIG. 6 is applied to the initiator, the processing module 610 may be configured to: determine a first message frame, wherein the first message frame may include information that at least one link of multiple links is to be switched to an awake state for multi-link communication; and the transceiver module 620 may be configured to: send the first message frame. That is, the communication apparatus 600 in this case may perform the communication method described with reference to FIG. 2 and the operations performed by the initiator in FIGS. 3 and 4, and repetitive descriptions are omitted herein for the sake of brevity.

In the case where the communication apparatus shown in FIG. 6 is applied to a receiver, the transceiver module 620 may be configured to: receive a first message frame, wherein the first message frame may include information that at least one link of multiple links is to be switched to an awake state for multi-link communication; and the processing module 610 may be configured to: control execution of a communication operation based on the first message frame. That is, in this case, the communication apparatus 600 may perform the communication method described with reference to FIG. 5 and the operations performed by the receiver in FIGS. 3 and 4, and repetitive descriptions are omitted herein for the sake of brevity.

Furthermore, the communication apparatus 600 shown in FIG. 6 is merely exemplary, and embodiments of the present disclosure are not limited thereto, e.g., the communication apparatus 600 may include other modules, such as, for example, a memory module and the like. In addition, individual modules in the communication apparatus 600 may be combined into more complex modules or may be divided into more separate modules.

The communication method and communication apparatus according to embodiments of the present disclosure may reduce the signaling interactions, enable the station in a PS state to engage in multi-link communication, and improve the efficiency of spectrum utilization.

Based on the same principles as the methods provided in embodiments of the present disclosure, embodiments of the present disclosure also provide an electronic device including a processor and a memory, wherein the memory stores machine-readable instructions (which may also be referred to as a “computer program”), and a processor is configured to execute the machine-readable instructions to implement the operations described in FIGS. 2 to 5. Embodiments of the present disclosure also provide a computer-readable storage medium having a computer program stored thereon, wherein the computer program is executed by the processor to cause the processor to implement the operations described with reference to FIGS. 2 to 5.

In some embodiments, the processor may be logic boxes, modules, and circuits for implementing or performing various embodiments described in conjunction with the present disclosure, such as, a Central Processing Unit (CPU), a general purpose processor, a Digital Signal Processor (DSP), an Application Specific Integrated Circuit (ASIC), a Field Programmable Gate Array (FPGA) or other programmable logic devices, transistor logic devices, hardware components, or any combination thereof. A processor may also be a combination that implements a computing function, such as a combination containing one or more microprocessors, a combination of a DSP and a microprocessor, and the like.

In some embodiments, the memory may be, for example, Read Only Memory (ROM), Random Access Memory (RAM), Electrically Erasable Programmable Read Only Memory (EEPROM), Compact Disc Read Only Memory (CD-ROM) or other optical disk storage, optical disk storage (including Compact Disc, Laser Disc, CD-ROM, Digital Versatile Disc, Blu-Ray Disc, etc.), magnetic storage media, or other magnetic storage devices, or any other medium that can be used to carry or store program code in the form of instructions or data structures and can be accessed by a computer, without limitation.

It is to be understood that although the individual steps in the flowchart of the accompanying drawings are shown in sequence as indicated by the arrows, the steps are not necessarily executed in the order indicated by the arrows in sequence. Unless expressly stated herein, the execution of these steps is not strictly limited in order, and they may be executed in other orders. In addition, at least a portion of the steps in the flowchart of the accompanying drawings may include a plurality of sub-steps or a plurality of phases, which may not necessarily executed and completed at the same moment but may be executed at different moments, and execution order of which is not necessarily sequential, but may be executed in turn or alternately with at least a portion of the other steps, or of the sub-steps or phases of the other steps.

While the present disclosure has been shown and described with reference to certain embodiments of the present disclosure, those skilled in the art will understand that various changes in form and detail can be made without departing from the scope of the present disclosure. Accordingly, the scope of the present disclosure should not be limited to being limited by the embodiments, but rather by the appended claims and their equivalents.

1. A communication method under multiple links, comprising:
determining a first message frame that includes information that at least one link of multiple links is to be switched to an awake state for multi-link communication; and
sending the first message frame.

2. The communication method of claim 1, wherein the information includes a power management identifier that is set to a first value to indicate that the at least one link is to be switched to the awake state.

3. The communication method of claim 1, wherein the information includes a link identifier corresponding to the at least one link.

4. The communication method of claim 1, wherein the information includes a delay identifier that is configured to identify a delay for a device under the at least one link to switch to an awake state.

5. The communication method of claim 1, further comprising:
receiving a second message frame from an access point that supports multi-link communication when the first message frame is sent by a station that supports multi-link communication,
wherein the second message frame includes information that a link is to be switched to an awake state recommended by the access point based on a communication environment.

6. The communication method of claim 5, wherein the communication environment includes at least one of a load situation or an access delay.

7. The communication method of claim 1, further comprising:
sending a third message frame that includes information that a link in the awake state in the at least one link is to enter into a power save mode.

8. A communication method under multiple links, comprising:
receiving a first message frame that includes information that at least one link of multiple links is to be switched to an awake state for multi-link communication; and
performing a communication operation based on the first message frame.

9. The communication method of claim 8, wherein the information includes a power management identifier that is set to a first value to indicate that the at least one link is to be switched to the awake state.

10. The communication method of claim 8, wherein the information includes a link identifier corresponding to the at least one link.

11. The communication method of claim 8, wherein the information includes a delay identifier that is configured to identify a delay for a device under the at least one link to switch to an awake state.

12. The communication method of claim 8, further comprising:
sending a second message frame to a station that supports multi-link communication when the first message frame is received by an access point that supports multi-link communication,
wherein the second message frame includes information that a link is to be switched to an awake state recommended by the access point based on a communication environment.

13. The communication method of claim 12, wherein the communication environment includes at least one of a load situation or an access delay.

14. The communication method of claim 8, further comprising:
receiving a third message frame that includes information that a link in the awake state in the at least one link is to enter into a power save mode.

15. (canceled)

16. (canceled)

17. An electronic device, comprising:
a processor; and
a memory storing instructions executable by the processor,
wherein the processor is configured to execute the instructions to:
determine a first message frame that includes information that at least one link of multiple links is to be switched to an awake state for multi-link communication; and
send the first message frame.

18. A non-transitory computer-readable storage medium storing instructions that, when executed by a processor, cause the processor to implement the method of claim 1.

19. The electronic device of claim 17, wherein the information includes at least one of: a power management identifier, a link identifier corresponding to the at least one link, and a delay identifier;
wherein the power management identifier is set to a first value to indicate that the at least one link is to be switched to the awake state; and
wherein the delay identifier is configured to identify a delay for a device under the at least one link to switch to an awake state.

20. The electronic device of claim 17, wherein the processor is further configured to:
receive a second message frame from an access point that supports multi-link communication when the first message frame is sent by a station that supports multi-link communication,
wherein the second message frame includes information that a link is to be switched to an awake state recommended by the access point based on a communication environment.

21. The electronic device of claim 17, wherein the processor is further configured to:
send a third message frame that includes information that a link in the awake state in the at least one link is to enter into a power save mode.

22. An electronic device, comprising:
a processor; and
a memory storing instructions executable by the processor,
wherein the processor is configured to execute the instructions to implement the method of claim 8.
